(19) United States
(12) Patent Application Publication
(10) Pub. No.: US 2025/0094887 A1
(43) Pub. Date: Mar. 20, 2025

(54) METHOD FOR OPTIMIZING PARAMETERS OF LADDER-TYPE CARBON TRADING MECHANISM BASED ON IMPROVED PARTICLE SWARM OPTIMIZATION (IPSO) ALGORITHM

(71) Applicants: State Grid Jiangsu Electric Power Co., Ltd. Economic Research Institute, Nanjing, Jiangsu (CN); State Grid Jiangsu Electric Power Co., Ltd., Nanjing, Jiangsu (CN)

(72) Inventors: Quan Chen, Nanjing, Jiangsu (CN); Xuanjun Zong, Nanjing, Jiangsu (CN); Sheng Zou, Nanjing, Jiangsu (CN); Hongwei Zhou, Nanjing, Jiangsu (CN); Tao Peng, Nanjing, Jiangsu (CN); Weiliang Wang, Nanjing, Jiangsu (CN); Wenjia Zhang, Nanjing, Jiangsu (CN); Chen Wu, Nanjing, Jiangsu (CN); Qun Zhang, Nanjing, Jiangsu (CN); Yuan Shen, Nanjing, Jiangsu (CN); Wei Feng, Nanjing, Jiangsu (CN); Gaofeng Shen, Nanjing, Jiangsu (CN); Min Zhang, Nanjing, Jiangsu (CN); Kai Yang, Nanjing, Jiangsu (CN); Xinyue Kong, Nanjing, Jiangsu (CN)

(21) Appl. No.: 18/015,345

(22) PCT Filed: Oct. 20, 2022
(86) PCT No.: PCT/CN2022/126350

§ 371 Date: Jan. 10, 2023

(30) Foreign Application Priority Data
Jun. 16, 2022 (CN) 202210680115.4

(51) Int. Cl. G06Q 10/04; G06Q 40/04

(52) U.S. Cl. CPC G06Q 10/04; G06Q 40/04

(57) ABSTRACT

The present disclosure provides a method for optimizing parameters of a ladder-type carbon trading mechanism based on an improved particle swarm optimization (IPSO) algorithm. The method first obtains information and operating data of a park-level integrated energy system, establishes equipment models and constraints of the park-level integrated energy system, and establishes a ladder-type carbon trading model; then encapsulates a process of optimized low-carbon dispatching of the park-level integrated energy system as a fitness function whose input is parameters of a carbon trading mechanism and output is a carbon emission of the system; and finally, introduces an IPSO algorithm to optimize the fitness function, and outputs optimization result information of the algorithm. The present disclosure verifies effectiveness and rationality of the model and the method that give full play to a role of the ladder-type carbon trading mechanism in the park-level integrated energy system through example analysis.

### TECHNICAL FIELD

The present disclosure relates to a ladder-type carbon trading mechanism, and specifically, to a method for optimizing parameters of a ladder-type carbon trading mechanism based on an improved particle swarm optimization (IPSO) algorithm.

### BACKGROUND

An efficient, safe, low-carbon and clean energy utilization technology is a mainstream direction of current energy development and an objective requirement of sustainable development in the world. In a park-level integrated energy system, flexible complementation of electricity, gas, heat, and other energy sources can meet demands of diversified loads and realize gradient utilization of energy. The energy industry accounts for a large proportion of a carbon emission and is a main force of energy conservation and emission reduction. In order to ensure sustainable development of the system, it is necessary to introduce carbon trading to give consideration to economical performance and low-carbon environmental protection of the park-level integrated energy system. There are mainly two kinds of carbon trading mechanisms: a ladder-type carbon trading mechanism and a traditional carbon trading mechanism. Compared with the traditional carbon trading mechanism, the ladder-type carbon trading mechanism controls the carbon emission more strictly. A final cost of the ladder-type carbon trading mechanism is closely related to a basic carbon trading price, a carbon emission interval length, and a carbon trading price growth rate that are selected. However, how to determine reasonable and effective parameters of the carbon trading mechanism remains to be further studied.

Therefore, when the ladder-type carbon trading mechanism is introduced to the park-level integrated energy system, it is of great significance to determine a reasonable basic carbon trading price, carbon emission range length, and price growth rate based on an actual condition of a park, so as to give full play to a role of the mechanism and maximally achieve low-carbon emission reduction.

### SUMMARY

The present disclosure is intended to provide a method for optimizing parameters of a ladder-type carbon trading mechanism based on an IPSO algorithm. This method determines reasonable parameters of a ladder-type carbon trading mechanism by using an IPSO algorithm and taking a process of optimized dispatching of an entire park-level integrated energy system as fitness function based on an actual condition of the park-level integrated energy system, so as to give full play to a role of the carbon trading mechanism, reduce a carbon emission of the system, and improve low-carbon operation of the system.

In order to achieve the above objective, the present disclosure adopts the following technical solutions:

A method for optimizing parameters of a ladder-type carbon trading mechanism based on an IPSO algorithm includes the following steps:
(1) collecting information and operating data of a park-level integrated energy system, including a topology framework of the park-level integrated energy system, a capacity and efficiency of an equipment in the park-level integrated energy system, a carbon emission coefficient of a gas turbine, a carbon emission coefficient of a gas boiler, an equivalent carbon emission coefficient of electricity purchased by a superior, an operating cost of the park-level integrated energy system, a constraint on safe operation of the park-level integrated energy system, and information of electric, heat, and gas loads;
(2) establishing a mathematical model of the equipment in the park-level integrated energy system, including a power-to-gas (P2G) equipment model, a gas turbine model, a gas boiler model, a battery model, a gas storage tank model, and a heat storage tank model;
(3) establishing a ladder-type carbon trading model, where the ladder-type trading model includes a carbon emission right quota model of the park-level integrated energy system, an actual carbon emission model of the park-level integrated energy system, and a ladder-type carbon emission trading model, and a mathematical expression of a ladder-type carbon trading cost obtained based on the ladder-type carbon trading model is as follows:

$${C}_{{CO}_{2}} = \{ \begin{matrix}λ {EX}_{p} & {EX}_{p} \leq l \\ λ ( 1 + σ ) ( {EX}_{p} - l ) + λ l & l \leq {EX}_{p} \leq 2 l \\ λ ( 1 + 2 σ ) ( {EX}_{p} - 2 l ) + λ ( 2 + σ ) l & 2 l \leq {EX}_{p} \leq 3 l \\ λ ( 1 + 3 σ ) ( {EX}_{p} - 3 l ) + λ ( 3 + 3 σ ) l & 3 l \leq {EX}_{p} \leq 4 l \\ λ ( 1 + 4 σ ) ( {EX}_{p} - 4 l ) + λ ( 4 + 4 σ ) l & {EX}_{p} \geq 4 l\end{matrix}$$

where C_{CO}_{₂} represents the ladder-type carbon transaction cost; λ represents a basic carbon trading price; l represents a carbon emission interval length; σ represents a carbon trading price growth rate; and EXₚ represents a carbon emission right trading volume of the park-level integrated energy system;
(4) taking a minimum overall cost constituted by the system operating cost Cᵣᵤₙ of the park-level integrated energy system and the ladder-type carbon trading cost C_{CO}_{₂} as a goal of optimized low-carbon economic dispatching, and encapsulating a process of the optimized low-carbon economic dispatching of the park-level integrated energy system as a fitness function, where an input of the fitness function includes three parameters of a ladder-type carbon trading mechanism, namely, the basic carbon trading price, the carbon emission interval length, and the carbon trading price growth rate, and an output of the fitness function is a carbon emission of the park-level integrated energy system; and
(5) introducing an IPSO algorithm to optimize the fitness function in the step (4), including adjusting an inertia weight in a particle swarm optimization (PSO) algorithm by taking an S-shaped function, a trigonometric function, and a random function as a carrier, and optimizing an acceleration factor in the PSO algorithm based on the trigonometric function to obtain optimization result information, where an optimization process includes performing iterative optimization on the fitness function by taking a maximum quantity of iterations as a termination condition and a lowest carbon emission of the system as a goal, and the optimization result information includes the basic carbon trading price, the carbon emission interval length, the carbon trading price growth rate, and the carbon emission of the park-level integrated energy system.

Further, a mathematical expression of the P2G equipment model is as follows:

P_{p2g_o}^{t}=η_{p2g}P_{p2g}^{t}
where P_{p2g_o}^{t} and P_{p2g}^{t} respectively represent an output and an input of P2G equipment at a time point t; and η_{p2g} represents P2G conversion efficiency;
a mathematical expression of the gas turbine model is as follows:

$$\{ \begin{matrix}{P}_{gt \_e}^{t} = {η}_{gte} {P}_{gt}^{t} \\ {P}_{gt \_ h}^{t} = {η}_{gth} {P}_{gt}^{t}\end{matrix}$$

where P_{gt_e}^{t}, P_{gt_h}^{t}, and P_{gt}^{t} respectively represent an output electricity quantity, an output heat amount, and an input gas amount of the gas turbine at the time point t; and η_{gte} and η_{gth} respectively represent gas-to-power efficiency and gas-to-heat efficiency of the gas turbine;
a mathematical expression of the gas boiler model is as follows:

P_{gb_o}^{t}=η_{gb}P_{gb}^{t}
where P_{gb_o}^{t} and P_{gb}^{t} respectively represent an output and an input of the gas boiler at the time point t; and η_{gb} represents conversion efficiency of the gas boiler; and
an electricity/gas/heat storage model includes three kinds of energy storage equipment: a battery, a heat storage tank, and a gas storage tank, and a unified universal model is adopted for processing, where the universal model includes a balance constraint of stored energy, constraints on upper and lower limits of the stored energy, a constraint on equal quantities at the beginning and end of an energy storage cycle, and power constraints of energy charging and discharging, and a mathematical expression of the universal model is as follows:

$$\{ \begin{matrix}{E}_{x}^{t + 1} = {E}_{x}^{t} + ( {P}_{xchar}^{t} {η}_{xchar} - {P}_{xdis}^{t} / {η}_{xdis} ) Δ t \\ {E}_{x}^{min} \leq {E}_{x}^{t} \leq {E}_{x}^{max} \\ {E}_{x}^{24} = {E}_{x}^{1} \\ 0 \leq {P}_{xdis}^{t} \leq ( 1 - {n}_{x} ) {P}_{xdis}^{max} \\ 0 \leq {P}_{xchar}^{t} \leq {n}_{x} {P}_{xchar}^{max}\end{matrix}$$

where x represents an energy type, which is set to electricity, heat or gas; Eₓ^{t} represents stored energy of an energy storage system in a unit time period t; P_{xchar}^{t} and P_{xdis}^{t} respectively represent energy charging power and energy discharging power of the energy storage system; η_{xchar} and η_{xdis} respectively represent energy charging efficiency and energy discharging efficiency of the energy storage system; Eₓ^{max} and Eₓ^{min} respectively represent upper and lower limits of the stored energy of the energy storage system; Eₓ¹ and Eₓ²⁴ respectively represent stored energy of the energy storage system at the beginning and end of one-day dispatching, where it is required that the stored energy of the energy storage system returns to an original value after the one-day dispatching; P_{xchar}^{max} and P_{xdis}^{max} respectively represent upper limits of the energy charging power and the energy discharging power of the energy storage system; nₓ represents a variable ranging from 0 to 1, which is used to ensure that the energy storage system stores and discharges energy at different time in each time period, where when nₓ is 1, the energy storage system stores the energy; or when nₓ is 0, the energy storage system discharges the energy; and Δt represents the unit time period.

Further, the ladder-type carbon trading model established in the step (3) includes the following sub-models:
a mathematical expression of the carbon emission right quota model is as follows:

$$\{ \begin{matrix}{EX}_{PIESo} = {EX}_{eo , buy} + {EX}_{gto} + {EX}_{gbo} \\ {EX}_{eo , buy} = {μ}_{e} {\sum }_{t = 1}^{T} {P}_{e}^{t} \\ {EX}_{gto} = {μ}_{h} {\sum }_{t = 1}^{T} ( {P}_{gt}^{t} {η}_{gte} {δ}_{e , h} + {P}_{gt}^{t} {η}_{gth} ) \\ {EX}_{gbo} = {μ}_{h} {\sum }_{t = 1}^{T} {P}_{e}^{t} {η}_{gb}\end{matrix}$$

where EX_{PIESo}, EX_{eo,buy}, EX_{gto}, and EX_{gbo} respectively represent a carbon emission right quota of the park-level integrated energy system, a carbon emission right quota of the electricity purchased by the superior, a carbon emission right quota of the gas turbine, and a carbon emission right quota of the gas boiler; μₑ and μₕ respectively represent a carbon emission right quota for generating unit electric power and a carbon emission right quota for generating unit thermal power; δ_{e,h} represent an electric power conversion parameter and a thermal power conversion parameter; Pₑ^{t}, P_{gt}^{t}, and P_{gb}^{t} respectively represent a quantity of electricity purchased by the superior, input power of the gas turbine, input power of the gas boiler at a time point t; η_{gte}, η_{gth}, and η_{gb} respectively represent gas-to-power efficiency of the gas turbine, gas-to-heat efficiency of the gas turbine, and conversion efficiency of the gas boiler; and T represents a dispatching cycle;
a mathematical expression of the actual carbon emission model is as follows:

$$\{ \begin{matrix}{EX}_{PIES} = {EX}_{e , buy} + {EX}_{gt} + {EX}_{gb} \\ {EX}_{e , buy} = {ξ}_{e} {\sum }_{t = 1}^{T} {P}_{e}^{t} \\ {EX}_{gt} = {ξ}_{h} {\sum }_{t = 1}^{T} ( {P}_{gt}^{t} {η}_{gte} {δ}_{e , h} + {P}_{gt}^{t} {η}_{gth} ) \\ {EX}_{gb} = {ξ}_{h} {\sum }_{t = 1}^{T} {P}_{gb}^{t} {η}_{gb}\end{matrix}$$

where EX_{PIES}, EX_{e,buy}, EX_{gt}, and EX_{gb} respectively represent an actual carbon emission of the park-level integrated energy system, an actual carbon emission of the electricity purchased by the superior, an actual carbon emission of the gas turbine, and an actual carbon emission of the gas boiler; and ξₑ and ξₕ respectively represent an actual carbon emission for generating the unit electric power and an actual carbon emission for generating the unit thermal power; and
an actual carbon emission right trading volume in a carbon trading market in the ladder-type carbon emission trading model is calculated according to the following formula:

$${EX}_{p} = {EX}_{PIESo} - {EX}_{PIES}$$

where EXₚ, EX_{PIESo}, and EX_{PIES} respectively represent the carbon emission right trading volume, the carbon emission right quota, and the actual carbon emission of the park-level integrated energy system.

Further, the step (4) specifically includes the following procedure:
determining an objective function, comprehensively considering the system operating cost Cᵣᵤₙ of the park-level integrated energy system and the ladder-type carbon trading cost C_{CO}_{₂}, and building the goal of the optimized low-carbon economic dispatching, namely, a lowest comprehensive operating cost C, where the goal of the optimized low-carbon economic dispatching is expressed as follows:

$$C = min ( {C}_{run} + {C}_{{CO}_{2}} )$$

a mathematical expression of the system operating cost is as follows:

$$\{ \begin{matrix}{C}_{run} = {C}_{buy} + {C}_{save} \\ {C}_{buy} = {\sum }_{t = 1}^{T} {α}_{t} {P}_{e}^{t} + {\sum }_{t = 1}^{T} {β}_{t} {P}_{g}^{t} \\ {C}_{save} = {\sum }_{t = 1}^{T} ( {Ψ}_{gt} {P}_{gt}^{t} + {Ψ}_{gb} {P}_{gb}^{t} + {Ψ}_{p 2 g} {P}_{p 2 g}^{t} + {Ψ}_{e} {P}_{edis}^{t} + {Ψ}_{h} {P}_{hdis}^{t} + {Ψ}_{g} {P}_{gdis}^{t} )\end{matrix}$$

where C_{buy} represents an energy purchasing cost; Cₛₐᵥₑ represents an equipment maintenance cost; Pₑ^{t} and P_{g}^{t} respectively represent a quantity of electricity purchased and an amount of gas purchased in a unit time period t; αₜ and βₜ respectively represent an electricity price and a gas price in the time period t; ψ_{gt}, ψ_{gb}, ψ_{p2g}, ψₑ, ψₕ, and ψ_{g} respectively represent unit maintenance costs of the gas turbine, the gas boiler, P2G equipment, a battery, a heat storage tank, and a gas storage tank; P_{gt}^{t}, P_{gb}^{t} and P_{p2g}^{t} respectively represent input power of the gas turbine, the gas boiler, and the P2G equipment at a time point t; P_{edis}^{t} represents discharging power of the battery in the unit time period t; P_{gdis}^{t} represents gas discharging power of the gas storage tank in the unit period t; and P_{hdis}^{t} represents heat discharging power of the heat storage tank in the unit time period t;
a mathematical expression of the ladder-type carbon trading cost is as follows:

$${EX}_{p} = {EX}_{PIESo} - {EX}_{PIES}$$

$${C}_{{CO}_{2}} = \{ \begin{matrix}λ {EX}_{p} & {EX}_{p} \leq l \\ λ ( 1 + σ ) ( {EX}_{p} - l ) + λ l & l \leq {EX}_{p} \leq 2 l \\ λ ( 1 + 2 σ ) ( {EX}_{p} - 2 l ) + λ ( 2 + σ ) l & 2 l \leq {EX}_{p} \leq 3 l \\ λ ( 1 + 3 σ ) ( {EX}_{p} - 3 l ) + λ ( 3 + 3 σ ) l & 3 l \leq {EX}_{p} \leq 4 l \\ λ ( 1 + 4 σ ) ( {EX}_{p} - 4 l ) + λ ( 4 + 6 σ ) l & {EX}_{p} \geq 4 l\end{matrix}$$

where EXₚ, EX_{PIESo}, and EX_{PIES} respectively represent the carbon emission right EX trading volume, a carbon emission right quota, and an actual carbon emission of the park-level integrated energy system; C_{CO}_{₂} represents the ladder-type carbon trading cost; λ represents the basic carbon trading price; l represents the carbon emission interval length; and σ represents the carbon trading price growth rate;
the objective function includes the following constraints: an electric, gas, and thermal power balance constraint, a wind power output constraint, a P2G equipment constraint, power output and ramping constraints of the gas turbine, power output and ramping constraints of the gas boiler, an electricity/gas/heat storage constraint, and electricity and gas purchasing constraints, where
the electric, gas, and thermal power balance constraint is as follows:

$$\{ \begin{matrix}{P}_{el}^{t} = {P}_{e}^{t} + {P}_{w}^{t} + {P}_{gt}^{t} {η}_{gte} + {P}_{edis}^{t} - {P}_{echar}^{t} - {P}_{p 2 g}^{t} \\ {P}_{gl}^{t} = {P}_{g}^{t} + {P}_{p 2 g}^{t} {η}_{p 2 g} + {P}_{gdis}^{t} - {P}_{gt}^{t} - {P}_{gchar}^{t} - {P}_{gb}^{t} \\ {P}_{hl}^{t} = {P}_{gt}^{t} {η}_{gth} + {P}_{hdis}^{t} + {P}_{gb}^{t} {η}_{gb} - {P}_{hchar}^{t}\end{matrix}$$

where P_{gl}^{t}, Pₕₗ^{t}, and Pₑₗ^{t} respectively represent power of the gas, heat, and electric loads in the park-level integrated energy system at the time point t; Pₑ^{t}, and P_{g}^{t} respectively represent a quantity of electricity purchased and an amount of gas purchased at the time point t; P_{w}^{t} represents wind power participating in dispatching at the time point t; P_{p2g}^{t}, P_{gt}^{t}, and P_{gb}^{t} respectively represent the input power of the P2G equipment, the gas turbine, and the gas boiler at the time point t; P_{gchar}^{t}, and P_{gdis}^{t} respectively represent gas storage power and gas discharging power of the gas storage tank at the time point t; P_{hchar}^{t}, and P_{hdis}^{t} respectively represent heat storage power and heat discharging power of the heat storage tank at the time point t; P_{echar}^{t}, and P_{edis}^{t} respectively represent charging power and discharging power of the battery at the time point t; η_{p2g} represents energy conversion efficiency of the P2G equipment; and η_{gte}, η_{gth}, and η_{gb} respectively represent gas-to-power efficiency of the gas turbine, gas-to-heat efficiency of the gas turbine, and conversion efficiency of the gas boiler;
the wind power output constraint is as follows:

0≤P_{w}^{t}≤P_{w}^{max}
where P_{w}^{max} represents an upper limit of a wind power output;
the P2G equipment constraint is as follows:

0≤P_{p2g}^{t}≤P_{p2gn}
where P_{p2gn} represents rated power of the P2G equipment;
the power output and ramping constraints of the gas turbine are as follows:

$$\{ \begin{matrix}0 \leq {P}_{gt}^{t} \leq {P}_{gtn} \\ Δ {P}_{gt}^{min} \leq {P}_{gt}^{t + 1} - {P}_{gt}^{t} \leq Δ {P}_{gt}^{max}\end{matrix}$$

where P_{gtn} represents rated power of the gas turbine; P_{gt}^{t} represents the input power of the gas turbine at the time point t; and ΔP_{gt}^{max} and ΔP_{gt}^{min} respectively represent upper and lower limits of a ramping rate of the gas turbine;
the power output and ramping constraints of the gas boiler are as follows:

$$\{ \begin{matrix}0 \leq {P}_{gb}^{t} \leq {P}_{gbn} \\ Δ {P}_{gb}^{min} \leq {P}_{gb}^{t + 1} - {P}_{gb}^{t} \leq Δ {P}_{gb}^{max}\end{matrix}$$

where P_{gbn} represents rated power of the gas boiler; P_{gb}^{t} represents the input power of the gas boiler at the time point t; and ΔP_{gb}^{max} and ΔP_{gb}^{min} respectively represent upper and lower limits of a ramping rate of the gas boiler;
the electricity/gas/heat storage constraint is as follows:
the battery, the heat storage tank, and the gas storage tank adopt a unified universal model for processing, including a balance constraint of stored energy, constraints on upper and lower limits of the stored energy, a constraint on equal quantities at the beginning and end of an energy storage cycle, and power constraints of energy charging and discharging:

$$\{ \begin{matrix}{E}_{x}^{t + 1} = {E}_{x}^{t} + ( {P}_{xchar}^{t} {η}_{xchar} - {P}_{xdis}^{t} / {η}_{xdis} ) Δ t \\ {E}_{x}^{min} \leq {E}_{x}^{t} \leq {E}_{x}^{max} \\ {E}_{x}^{24} = {E}_{x}^{1} \\ 0 \leq {P}_{xdis}^{t} \leq ( 1 - {n}_{x} ) {P}_{xdis}^{max} \\ 0 \leq {P}_{xchar}^{t} \leq {n}_{x} {P}_{xchar}^{max}\end{matrix}$$

where x represents an energy type, which is set to electricity, heat or gas; Eₓ^{t} represents stored energy of an energy storage system in the unit time period t; P_{xcha}^{t} and P_{xdis}^{t} respectively represent energy charging power and energy discharging power of the energy storage system; η_{xchar} and η_{xdis} respectively represent energy charging efficiency and energy discharging efficiency of the energy storage system; Eₓ^{max} and Eₓ^{min} respectively represent upper and lower limits of the stored energy of the energy storage system; Eₓ¹ and Eₓ²⁴ respectively represent stored energy of the energy storage system at the beginning and end of the one-day dispatching, where it is required that the stored energy of the energy storage system returns to an original value after the one-day dispatching; P_{xchar}^{max} and P_{xdis}^{max} respectively represent upper limits of the energy charging power and the energy discharging power of the energy storage system; and nₓ represents a variable ranging from 0 to 1, which is used to ensure that the energy storage system stores and discharges energy at different time in each time period, where when nₓ is 1, the energy storage system stores the energy; or when the variable is 0, the energy storage system discharges the energy; and
the park-level integrated energy system is connected to an external power network and natural gas network, and an energy exchange scope of the park-level integrated energy system needs to be constrained, where the electricity and gas purchasing constraints are determined as follows:

$$\{ \begin{matrix}{P}_{e}^{min} \leq {P}_{e}^{t} \leq {P}_{e}^{max} \\ {P}_{g}^{min} \leq {P}_{g}^{t} \leq {P}_{g}^{max}\end{matrix}$$

where P_{xchar}^{max} and P_{xdis}^{max} respectively represent upper and lower limits of electric power purchased by the system in the unit time period t; and P_{g}^{max} and P_{g}^{min} respectively represent upper and lower limits of natural gas power purchased by the system.

Further, in the step (5), the introducing an IPSO algorithm to optimize the fitness function in the step (4) specifically includes:
improving the inertia weight: taking the S-shaped function, the trigonometric function, and the random function as the carrier, and optimizing and adjusting ω, where an expression for improving the inertia weight is as follows:

$$ω = \frac{1}{1 + {e}^{- \frac{k}{iter}}} - 0.1 + rand * cos ( \frac{π}{2} * \frac{iter}{Iter\_max} )$$

where ω represents the inertia weight; iter represents a current quantity of iterations; Iter_max represents the maximum quantity of iterations; rand represents a uniformly distributed random number of [0,1]; and k represents a constant, and k=30;
improving the acceleration factor: improving and nonlinearly adjusting the acceleration factor based on the trigonometric function, where a calculation formula for improving the acceleration factor is as follows:

$${c}_{1} = 2 - 1.5 * sin ( \frac{π}{2} * \frac{iter}{Iter\_max} )$$

$${c}_{2} = 0.5 + 1.5 * sin ( \frac{π}{2} * \frac{iter}{Iter\_max} )$$

where c₁ and c₂ represent acceleration factors; iter represents the current quantity of iterations; Iter_max represents the maximum quantity of iterations; and value ranges of c₁ and c₂ are [0.5,2]; and
optimizing the IPSO algorithm, which specifically includes step 1 to step 8:
step 1: initializing the algorithm, and setting a swarm size m, a particle dimension d, the acceleration factors c₁ and c₂, a maximum flight speed Vₘₐₓ of a particle, a minimum flight speed min of the particle, and the maximum quantity of iterations Iter_max;
step 2: randomly initializing a speed and a position of the particle within a specified search range;
step 3: calculating an inertia weight and an acceleration factor of the particle before a next iteration based on the calculation formula for improving the inertia weight and the calculation formula for improving the acceleration factor;
step 4: calculating the speed and the position of the particle;
step 5: calculating a fitness value fᵢ of each particle based on the set fitness function, calculating an individual extremum P_{best} and a global extremum G_{best} based on fᵢ, comparing fᵢ with the individual extremum P_{best}, and if a result shows that fᵢ is superior to the individual extremum P_{best}, setting P_{best}=fᵢ;
step 6: comparing the individual extremum P_{best} of each particle with the global extremum G_{best} in a swarm, and if a result shows that P_{best} is superior to the global extremum G_{best}, setting G_{best}=P_{best};
step 7: determining whether the termination condition described in the step (5) is met; and if the termination condition is met, stopping the operation and performing step 8; or if the termination condition is not met, returning to the step 3; and
step 8: outputting a global optimal value.

Compared with the prior art, the present disclosure has the following beneficial effects: The method for optimizing parameters of a ladder-type carbon trading mechanism based on an IPSO algorithm in the present disclosure has the following substantive characteristics and significant improvements:
(1) An intelligent algorithm is used to perform optimization, which avoids manual formulation of the parameters of the ladder-type carbon trading mechanism.
(2) Optimization is performed by using the IPSO algorithm based on a specific condition of the park-level integrated energy system, thereby improving rationality of the parameter formulation of the ladder-type carbon trading mechanism.
(3) Reasonable parameter formulation can give full play to effectiveness of the carbon trading mechanism.
(4) The functioning of the carbon trading mechanism reduces the carbon emission of the park-level integrated energy system and improves a low-carbon nature of the system.

### BRIEF DESCRIPTION OF THE DRAWINGS

FIG. 1 is an implementation flowchart according to the present disclosure;

FIG. 2 is an example structural diagram of a park-level integrated energy storage system according to the present disclosure;

FIG. 3 shows predicted power output data of an electric load, a gas load, a heat load, and wind power according to an embodiment;

FIG. 4 shows a relationship between a basic carbon trading price and a carbon emission of a system;

FIG. 5 shows a relationship between a carbon emission interval length and a carbon emission of a system;

FIG. 6 shows a relationship between a carbon trading price growth rate and a carbon emission of a system; and

FIG. 7 shows an optimization iteration of an IPSO algorithm.

### DETAILED DESCRIPTION

The technical solutions of the present disclosure will be described in detail below with reference to the accompanying drawings and specific embodiments, but the protection scope of the present disclosure is not limited to the embodiments.

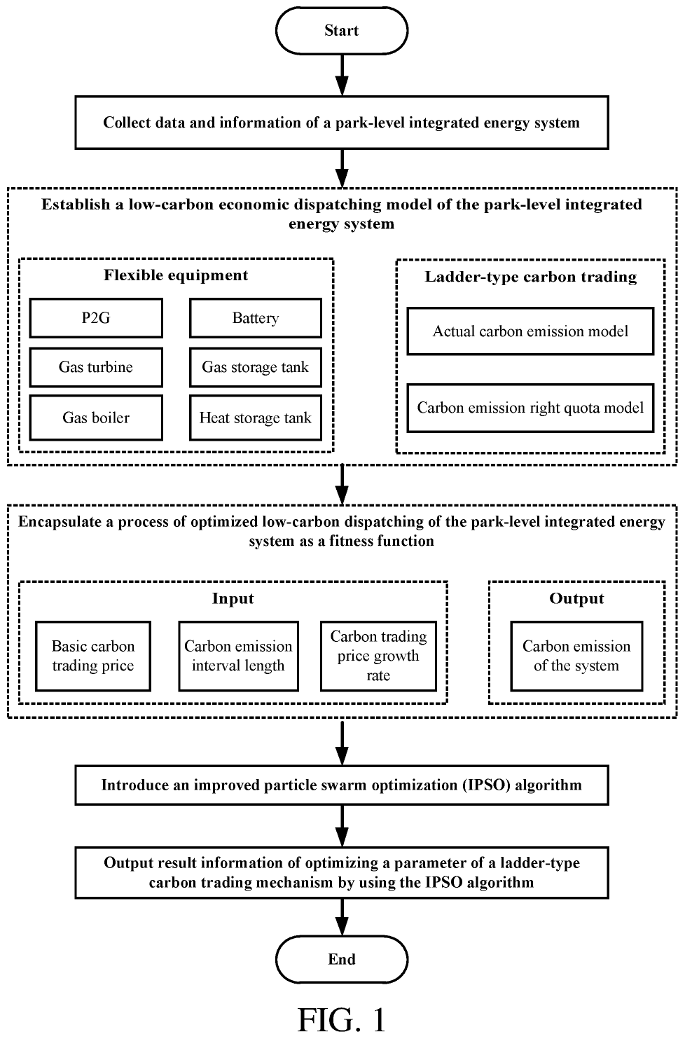

As shown in FIG. 1, a method for optimizing parameters of a ladder-type carbon trading mechanism based on an IPSO algorithm includes the following steps.
(1) Collect data and information of a park-level integrated energy system.

The data and the information of the park-level integrated energy system are collected, including a capacity and efficiency of an equipment in the park-level integrated energy system, a carbon emission coefficient of a gas turbine, a carbon emission coefficient of a gas boiler, an equivalent carbon emission coefficient of electricity purchased by a superior, a topology framework of the park-level integrated energy system, an operating cost of the park-level integrated energy system, a constraint on safe operation of the park-level integrated energy system, and information of electric, heat, and gas loads.
(2) Establish an equipment model of the park-level integrated energy system, including:

### A. P2G Equipment Model

A mathematical expression of the P2G equipment model is as follows:

P_{p2g_o}^{t}=η_{p2g}P_{p2g}^{t}
where P_{p2g_o}^{t} and P_{p2g}^{t} respectively represent an output and an input of P2G equipment at a time point t; and η_{p2g} represents P2G conversion efficiency;

### B. Gas Turbine Model

A mathematical expression of the gas turbine model is as follows:

$$\{ \begin{matrix}{P}_{gt \_ e}^{t} = {η}_{gte} {P}_{gt}^{t} \\ {P}_{gt \_ h}^{t} = {η}_{gth} {P}_{gt}^{t}\end{matrix}$$

where P_{gt_e}^{t}, P_{gt_h}^{t}, and P_{gt}^{t} respectively represent an output electricity quantity, an output heat amount, and an input gas amount of the gas turbine at the time point t; and η_{gte} and η_{gth} respectively represent gas-to-power efficiency and gas-to-heat efficiency of the gas turbine;

### C. Gas Boiler Model

A mathematical expression of the gas boiler model is as follows:

P_{gb_o}^{t}=η_{gb}P_{gb}^{t}
where P_{gb_o}^{t} and P_{gb}^{t} respectively represent an output and an input of the gas boiler at the time point t; and represents conversion efficiency of the gas boiler.

### D. Electricity/Gas/Heat Storage Model

The electricity/gas/heat storage model includes three kinds of energy storage equipment: a battery, a heat storage tank, and a gas storage tank, and a unified universal model is adopted for processing, where the universal model includes a balance constraint of stored energy, constraints on upper and lower limits of the stored energy, a constraint on equal quantities at the beginning and end of an energy storage cycle, and power constraints of energy charging and discharging, and a mathematical expression of the universal model is as follows:

$$\{ \begin{matrix}{E}_{x}^{t + 1} = {E}_{x}^{t} + ( {P}_{xchar}^{t} {η}_{xchar} - {P}_{xdis}^{t} / {η}_{xdis} ) Δ t \\ {E}_{x}^{min} \leq {E}_{x}^{t} \leq {E}_{x}^{max} \\ {E}_{x}^{24} = {E}_{x}^{1} \\ 0 \leq {P}_{xdis}^{t} \leq ( 1 - {n}_{x} ) {P}_{xdis}^{max} \\ 0 \leq {P}_{xchar}^{t} \leq {n}_{x} {P}_{xchar}^{max}\end{matrix}$$

where x represents an energy type, which is set to electricity, heat or gas; Eₓ^{t} represents stored energy of an energy storage system in a unit time period t; Eₓ^{t+1} represents stored energy of the energy storage system in a unit time period t+1, where the energy storage system is the battery, the gas storage tank, or the heat storage tank; P_{xchar}^{t} and P_{xdis}^{t}, respectively represent energy charging power and energy discharging power of the energy storage system; η_{xchar} and η_{xdis} respectively represent energy charging efficiency and energy discharging efficiency of the energy storage system; Eₓ^{max} and Eₓ^{min} respectively represent upper and lower limits of the stored energy of the energy storage system; Eₓ¹ and Eₓ²⁴ respectively represent stored energy of the energy storage system at the beginning and end of one-day dispatching, where it is required that the stored energy of the energy storage system returns to an original value after the one-day dispatching; Eₓ^{max} and Eₓ^{min} respectively represent upper limits of the energy charging power and the energy discharging power of the energy storage system; nₓ represents a variable ranging from 0 to 1, which is used to ensure that the energy storage system stores and discharges energy at different time in each time period, where when nₓ is 1, the energy storage system stores the energy; or when nₓ is 0, the energy storage system discharges the energy; and Δt represents the unit time period.
(3) Establish a ladder-type carbon trading model, including:

### A. Carbon Emission Right Quota Model of the Park-Level Integrated Energy System

A mathematical expression of the carbon emission right quota model is as follows:

$$\{ \begin{matrix}{EX}_{PIESo} = {EX}_{eo , buy} + {EX}_{gto} + {EX}_{gbo} \\ {EX}_{eo , buy} = {μ}_{e} {\sum }_{t = 1}^{T} {P}_{e}^{t} \\ {EX}_{gto} = {μ}_{h} {\sum }_{t = 1}^{T} ( {P}_{gt}^{t} {η}_{gte} {δ}_{e , h} + {P}_{gt}^{t} {η}_{gth} ) \\ {EX}_{gbo} = {μ}_{h} {\sum }_{t = 1}^{T} {P}_{gb}^{t} {η}_{gb}\end{matrix}$$

where EX_{PIESo}, EX_{eo,buy}, EX_{gto}, and EX_{gbo} respectively represent a carbon emission right quota of the park-level integrated energy system, a carbon emission right quota of the electricity purchased by the superior, a carbon emission right quota of the gas turbine, and a carbon emission right quota of the gas boiler; μₑ and μₕ respectively represent a carbon emission right quota for generating unit electric power and a carbon emission right quota for generating unit thermal power; δ_{e,h} represent an electric power conversion parameter and a thermal power conversion parameter; Pₑ^{t}, P_{gt}^{t}, and P_{gb}^{t} respectively represent a quantity of electricity purchased by the superior, input power of the gas turbine, input power of the gas boiler at a time point t; η_{gte}, η_{gth}, and η_{gb} respectively represent gas-to-power efficiency of the gas turbine, gas-to-heat efficiency of the gas turbine, and conversion efficiency of the gas boiler; and T represents a dispatching cycle.

### B. Actual Carbon Emission Model

A mathematical expression of the actual carbon emission model is as follows:

$$\{ \begin{matrix}{EX}_{PIES} = {EX}_{e , buy} + {EX}_{gt} + {EX}_{gb} \\ {EX}_{e , buy} = {ξ}_{e} {\sum }_{t = 1}^{T} {P}_{e}^{t} \\ {EX}_{gt} = {ξ}_{h} {\sum }_{t = 1}^{T} ( {P}_{gt}^{t} {η}_{gte} {δ}_{e , h} + {P}_{gt}^{t} {η}_{gth} ) \\ {EX}_{gb} = {ξ}_{h} {\sum }_{t = 1}^{T} {P}_{gb}^{t} {η}_{gb}\end{matrix}$$

where EX_{PIES}, EX_{e,buy}, EX_{gt}, and EX_{gb} respectively represent an actual carbon emission of the park-level integrated energy system, an actual carbon emission of the electricity purchased by the superior, an actual carbon emission of the gas turbine, and an actual carbon emission of the gas boiler; and ξₑ and ξₕ respectively represent an actual carbon emission for generating the unit electric power and an actual carbon emission for generating the unit thermal power.

### C. Ladder-Type Carbon Emission Trading Model

After the carbon emission right quota and the actual carbon emission of the park-level integrated energy system are calculated, an actual carbon emission right trading volume in a carbon trading market can be obtained:

$${EX}_{p} = {EX}_{PIESo} - {EX}_{PIES}$$

where EXₚ represents the carbon emission right trading volume of the park-level integrated energy system; and EX_{PIESo} and EX_{PIES} respectively represent the carbon emission right quota and the actual carbon emission of the park-level integrated energy system.

In order to further limit the carbon emission, the present disclosure adopts a ladder-type pricing mechanism different from an existing carbon trading pricing mechanism. The ladder-type pricing mechanism sets a plurality of purchasing ranges. A larger carbon emission right quota to be purchased leads to a higher purchasing price of a corresponding range. A ladder-type carbon trading cost is calculated according to the following formula:

$${C}_{{CO}_{2}} = \{ \begin{matrix}λ {EX}_{p} & {EX}_{p} \leq l \\ λ ( 1 + σ ) ( {EX}_{p} - l ) + λ l & l \leq {EX}_{p} \leq 2 l \\ λ ( 1 + 2 σ ) ( {EX}_{p} - 2 l ) + λ ( 2 + σ ) l & 2 l \leq {EX}_{p} \leq 3 l \\ λ ( 1 + 3 σ ) ( {EX}_{p} - 3 l ) + λ ( 3 + 3 σ ) l & 3 l \leq {EX}_{p} \leq 4 l \\ λ ( 1 + 4 σ ) ( {EX}_{p} - 4 l ) + λ ( 4 + 6 σ ) l & {EX}_{p} \geq 4 l\end{matrix}$$

where C_{CO}_{₂} represents the ladder-type carbon trading cost; λ represents a basic carbon trading price; l represents a carbon emission interval length; σ represents a carbon trading price growth rate; and p represents the carbon emission right trading volume of the EX park-level integrated energy system.
(4) Encapsulate a process of optimized low-carbon economic dispatching of the park-level integrated energy system as a fitness function, where the process includes the equipment model and the ladder-type carbon trading model to reduce the operating cost and the carbon emission. Specifically, the following steps are included:

### A. Determine an Objective Function.

The system operating cost Cᵣᵤₙ of the park-level integrated energy system and the C ladder-type carbon trading cost C_{CO}_{₂} are comprehensively considered, and the goal of the optimized low-carbon economic dispatching, namely, a lowest comprehensive operating cost C, is built.

$$C = min ( {C}_{run} + {C}_{{CO}_{2}} )$$

A1. A mathematical expression of the system operating cost is as follows:

$$\{ \begin{matrix}{C}_{run} & = {C}_{buy} + {C}_{save} \\ {C}_{buy} & = {\sum }_{t = 1}^{T} {α}_{t} {P}_{e}^{t} + {\sum }_{t = 1}^{T} {β}_{t} {P}_{g}^{t} \\ {C}_{save} & = {\sum }_{t = 1}^{T} ( {ψ}_{gt} {P}_{gt}^{t} + {ψ}_{gb} {P}_{gb}^{t} + {ψ}_{p 2 g} {P}_{p 2 g}^{t} + {ψ}_{e} {P}_{edis}^{t} + {ψ}_{h} {P}_{hdis}^{t} + {ψ}_{g} {P}_{gdis}^{t} )\end{matrix}$$

where C_{buy} represents an energy purchasing cost; Cₛₐᵥₑ represents an equipment maintenance cost; Pₑ^{t} and P_{g}^{t} respectively represent a quantity of electricity purchased and an amount of gas purchased in a unit time period t; αₜ and βₜ respectively represent an electricity price and a gas price in the time period t; ψ_{gt}, ψ_{gb}, ψ_{p2g}, ψₑ, ψₕ, and ψ_{g} respectively represent unit maintenance costs of the gas turbine, the gas boiler, P2G equipment, a battery, a heat storage tank, and a gas storage tank; P_{gt}^{t}, P_{gb}^{t} and P_{p2g}^{t} respectively represent input power of the gas turbine, the gas boiler, and the P2G equipment at a time point t; P_{edis}^{t} represents discharging power of the battery in the unit time period t; P_{gdis}^{t} represents gas discharging power of the gas storage tank in the unit period t; and P_{hdis}^{t} represents heat discharging power of the heat storage tank in the unit time period t.
A2. A mathematical expression of the ladder-type carbon trading cost is as follows:

$${EX}_{p} = {EX}_{PIESo} - {EX}_{PIES}$$

where EXₚ, EX_{PIESo}, and EX_{PIES} respectively represent the carbon emission right trading volume, the carbon emission right quota, and the actual carbon emission of the park-level integrated energy system.

$${C}_{{CO}_{2}} = \{ \begin{matrix}λ {EX}_{p} & {EX}_{p} \leq l \\ λ ( 1 + σ ) ( {EX}_{p} - l ) + λ l & l \leq {EX}_{p} \leq 2 l \\ λ ( 1 + 2 σ ) ( {EX}_{p} - 2 l ) + λ ( 2 + σ ) l & 2 l \leq {EX}_{p} \leq 3 l \\ λ ( 1 + 3 σ ) ( {EX}_{p} - 3 l ) + λ ( 3 + 3 σ ) l & 3 l \leq {EX}_{p} \leq 4 l \\ λ ( 1 + 4 σ ) ( {EX}_{p} - 4 l ) + λ ( 4 + 6 σ ) l & {EX}_{p} \geq 4 l\end{matrix}$$

where C_{CO}_{₂} represents the ladder-type carbon trading cost; λ represents the basic carbon trading price; l represents the carbon emission interval length; and ø represents the carbon trading price growth rate.
B. The objective function includes the following constraints:

### B1: Electric, Gas, and Thermal Power Balance Constraint

The electric, gas, and thermal power balance constraint is as follows:

$$\{ \begin{matrix}{P}_{el}^{t} & = {P}_{e}^{t} + {P}_{w}^{t} + {P}_{gt}^{t} {η}_{gte} + {P}_{edis}^{t} - {P}_{echar}^{t} - {P}_{p 2 g}^{t} \\ {P}_{gl}^{t} & = {P}_{g}^{t} + {P}_{p 2 g}^{t} {η}_{p 2 g} + {P}_{gdis}^{t} + {P}_{gt}^{t} - {P}_{gchar}^{t} - {P}_{gb}^{t} \\ {P}_{hl}^{t} & = {P}_{gt}^{t} {η}_{gth} + {P}_{hdis}^{t} + {P}_{gb}^{t} {η}_{gb} - {P}_{hchar}^{t}\end{matrix}$$

where P_{gl}^{t}, Pₕₗ^{t}, and Pₑₗ^{t} respectively represent power of the gas, heat, and electric loads in the park-level integrated energy system at the time point t; Pₑ^{t}, and P_{g}^{t} respectively represent a quantity of electricity purchased and an amount of gas purchased at the time point t; P_{w}^{t} represents wind power participating in dispatching at the time point t; P_{p2g}^{t}, P_{gt}^{t}, and P_{gb}^{t} respectively represent the input power of the P2G equipment, the gas turbine, and the gas boiler at the time point t; P_{gchar}^{t}, and P_{gdis}^{t} respectively represent gas storage power and gas discharging power of the gas storage tank at the time point t; P_{hchar}^{t}, and P_{hdis}^{t} respectively represent heat storage power and heat discharging power of the heat storage tank at the time point t; P_{echar}^{t}, and P_{edis}^{t} respectively represent charging power and discharging power of the battery at the time point t; η_{p2g} represents energy conversion efficiency of the P2G equipment; and η_{gte}, η_{gth}, and η_{gb} respectively represent gas-to-power efficiency of the gas turbine, gas-to-heat efficiency of the gas turbine, and conversion efficiency of the gas boiler.

### B2. Wind Power Output Constraint

0≤P_{w}^{t}≤P_{w}^{max}.
where P_{w}^{max} represents an upper limit of a wind power output.

### B3. P2G Equipment Constraint

0≤P_{p2g}^{t}≥P_{p2gn}
where P_{p2gn} represents rated power of the P2G equipment.

### B4. Power Output and Ramping Constraints of the Gas Turbine

$$\{ \begin{matrix}0 \leq {P}_{gt}^{t} \leq {P}_{gtn} \\ Δ {P}_{gt}^{min} \leq {P}_{gt}^{t + 1} - {P}_{gt}^{t} \leq Δ {P}_{gt}^{max}\end{matrix}$$

where P_{gtn} represents rated power of the gas turbine; P_{gt}^{t} represents the input power of the gas turbine at the time point t; and ΔP_{gt}^{max} and ΔP_{gt}^{min} respectively represent upper and lower limits of a ramping rate of the gas turbine.

### B5. Power Output and Ramping Constraints of the Gas Boiler

$$\{ \begin{matrix}0 \leq {P}_{gb}^{t} \leq {P}_{gbn} \\ Δ {P}_{gb}^{min} \leq {P}_{gb}^{t + 1} - {P}_{gb}^{t} \leq Δ {P}_{gb}^{max}\end{matrix}$$

where P_{gbn} represents rated power of the gas boiler; P_{gb}^{t} represents the input power of the gas boiler at the time point t; and ΔP_{gb}^{max} and ΔP_{gb}^{min} respectively represent upper and lower limits of a ramping rate of the gas boiler.

### B6. Electricity/Gas/Heat Storage Constraint

The battery, the heat storage tank, and the gas storage tank adopt the unified universal model for processing, including a balance constraint of stored energy, constraints on upper and lower limits of the stored energy, a constraint on equal quantities at the beginning and end of an energy storage cycle, and power constraints of energy charging and discharging:

$$\{ \begin{matrix}{E}_{x}^{t + 1} = {E}_{x}^{t} + ( {P}_{xchar}^{t} {η}_{xchar} - {P}_{xdis}^{t} / {η}_{xdis} ) Δ t \\ {E}_{x}^{min} \leq {E}_{x}^{t} \leq {E}_{x}^{max} \\ {E}_{x}^{24} = {E}_{x}^{1} \\ 0 \leq {P}_{xdis}^{t} \leq ( 1 - {n}_{x} ) {P}_{xdis}^{max} \\ 0 \leq {P}_{xchar}^{t} \leq {n}_{x} {P}_{xchar}^{max}\end{matrix}$$

where x represents the energy type, which is set to the electricity, the heat or the gas; Eₓ^{t} represents the stored energy of the energy storage system in the unit time period t; P_{xchar}^{t} and P_{xdis}^{t} respectively represent the energy charging power and the energy discharging power of the energy storage system; η_{xchar} and η_{xdis} respectively represent the energy charging efficiency and the energy discharging efficiency of the energy storage system; Eₓ^{max} and Eₓ^{min} respectively represent the upper and lower limits of the stored energy of the energy storage system; Eₓ¹ and Eₓ²⁴ respectively represent the stored energy of the energy storage system at the beginning and end of the one-day dispatching, where it is required that the stored energy of the energy storage system returns to the original value after the one-day dispatching; P_{xchar}^{max} and P_{xdis}^{max} respectively represent the upper limits of the energy charging power and the energy discharging power of the energy storage system; and nₓ represents the variable ranging from 0 to 1, which is used to ensure that the energy storage system stores and discharges the energy at different time in each time period, where when nₓ is 1, the energy storage system stores the energy; or when the variable is 0, the energy storage system discharges the energy.

### B7. Electricity and Gas Purchasing Constraints

The park-level integrated energy system is connected to an external power network and natural gas network, and an energy exchange scope of the park-level integrated energy system needs to be constrained:

$$\{ \begin{matrix}{P}_{e}^{min} \leq {P}_{e}^{t} \leq {P}_{e}^{max} \\ {P}_{g}^{min} \leq {P}_{g}^{t} \leq {P}_{g}^{max}\end{matrix}$$

where Pₑ^{max} and Pₑ^{min} respectively represent upper and lower limits of electric power purchased by the system in the unit time period t; and P_{g}^{max} and P_{g}^{min} respectively represent upper and lower limits of natural gas power purchased by the system.

Accordingly, the present disclosure establishes a low-carbon economic dispatching model of the park-level integrated energy system.

Due to different actual conditions of different parks, corresponding carbon emissions are very different, but there is no general method for formulating corresponding parameters of the carbon trading mechanism based on a specific condition of the system. Therefore, the process of the optimized dispatching of the park-level integrated energy system is encapsulated as the fitness function in the step (4), which makes it convenient to subsequently introduce an IPSO algorithm to optimize the parameters of the carbon trading mechanism. An input of the fitness function is the basic carbon trading price, the carbon emission interval length, and carbon trading price growth rate, and an output is the carbon emission of the system.
(5) Introduce the IPSO algorithm to optimize the fitness function in the step (4) according to the following specific procedure:

### A. Improve an Inertia Weight.

In order to improve a search speed and search accuracy of a PSO algorithm in space, an S-shaped-trigonometric function PSO algorithm is introduced to optimize and adjust @ by taking an S-shaped function, a trigonometric function, and a random function as a carrier, so as to further improve an overall optimization capability of the algorithm. After this method is used for improvement, the algorithm converges slowly in an early stage, which is helpful to expand a search scope; and ω declines fast in middle and late stages, which is conducive to group learning, so as to quickly converge to a global optimal solution. An expression for improving the inertia weight is as follows:

$$ω = \frac{1}{1 + {e}^{- \frac{k}{i t e r}}} - 0.1 + r a n d * cos ( \frac{π}{2} * \frac{i t e r}{Iter\_max} )$$

where ω represents the inertia weight; iter represents a current quantity of iterations; Iter_max represents the maximum quantity of iterations; rand represents a uniformly distributed random number of [0,1]; and k represents a constant, and k=30.

### B. Improve an Acceleration Factor.

The acceleration factor is improved and nonlinearly adjusted based on the trigonometric function to improve a search capability of the algorithm. A calculation formula for improving the acceleration factor is improved is as follows:

$${c}_{1} = 2 - 1.5 * sin ( \frac{π}{2} * \frac{i t e r}{Iter\_max} )$$

$${c}_{2} = 0.5 + 1.5 * sin ( \frac{π}{2} * \frac{i t e r}{Iter\_max} )$$

where c₁ and c₂ represent a first acceleration factor and a second acceleration factor; iter represents the current quantity of iterations; Iter_max represents the maximum quantity of iterations; and value ranges of c₁ and c₂ are [0.5,2].

### C. Optimize the IPSO Algorithm.

An operation process of the IPSO algorithm is as follows:
Step 1: Initialize the algorithm, and set a swarm size m, a particle dimension d, the first acceleration factor c₁, the second accelerator factor c₂, a maximum flight speed Vₘₐₓ of a particle, a minimum flight speed Vₘᵢₙ of the particle, and the maximum quantity of iterations Iter_max.
Step 2: Randomly initialize a speed and a position of the particle within a specified search range.
Step 3: Calculate an inertia weight and an acceleration factor of the particle before a next iteration based on the calculation formula for improving the inertia weight and the calculation formula for improving the acceleration factor.
Step 4: Calculate the speed and the position of the particle.
Step 5: Calculate a fitness value fᵢ of each particle based on the set fitness function, calculate an individual extremum P_{best} and a global extremum G_{best} based on fᵢ, compare fᵢ with the individual extremum P_{best}, and if a result shows that fᵢ is superior to the individual extremum P_{best}, set P_{best}=fᵢ.
Step 6: Compare the individual extremum of each particle with the global extremum G_{best} in a swarm, and if a result shows that the individual extremum P_{best} is superior to the global extremum Gest set G_{best}=P_{best}.
Step 7: Determine whether the termination condition is met (the preset maximum quantity of iterations is reached); and if the termination condition is met, enable the algorithm to stop the operation and perform step 8; or if the termination condition is not met, return to the step 3.
Step 8: Output a global optimal value.
(6) Output optimization result information in the step (5).

In the step (5), after the fitness function described in the step (4) is optimized by using the IPSO algorithm, so as to minimize the carbon emission of the system, the corresponding optimization result information of the algorithm is output. The optimization result information includes the basic carbon trading price, the carbon emission interval length, the carbon trading price growth rate, and the carbon emission of the system.

### Embodiment

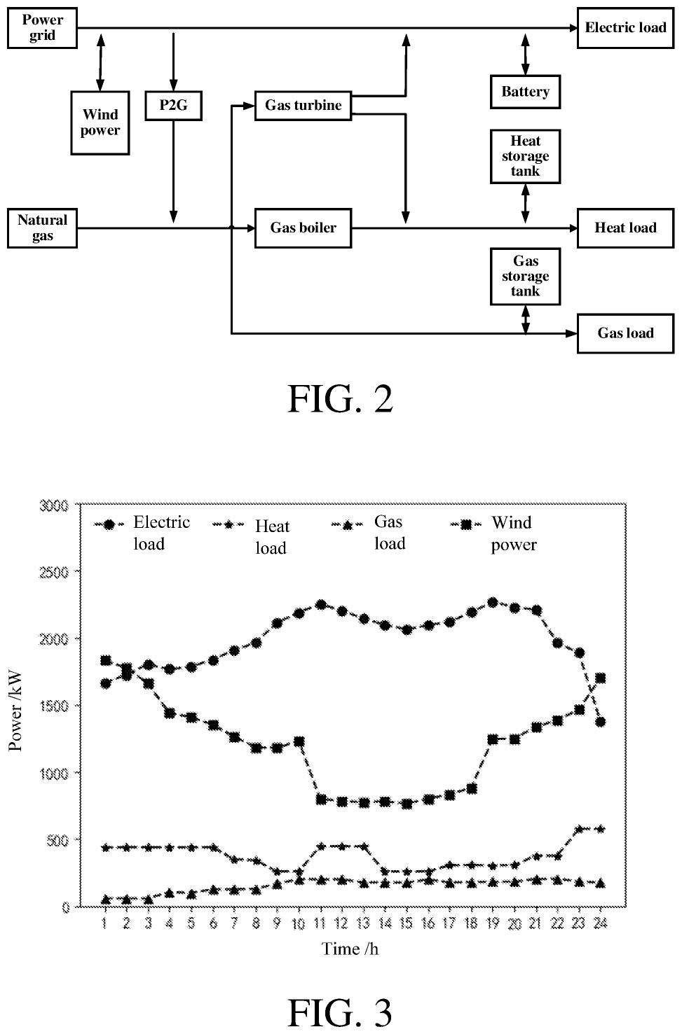

A structure of a park-level integrated energy system involved in the present disclosure is shown in FIG. 2, and 24 hours are taken as one dispatching cycle. FIG. 3 shows predicated values of a required wind power output and required electric, heat and gas load in a park-level integrated energy system. It is assumed that a fluctuation error of a power output of a renewable wind turbine is ±10%. Based on a calorific value of fuel, a carbon content of the fuel, efficiency of the fuel in each carbon emission link, and other factors, a unit carbon emission of each carbon emission link is determined. That is, an equivalent carbon emission δₑ of electricity purchased is 1.08 kg/(kW·h), and a carbon emission δₕ of a gas boiler is 0.065 kg/MJ. After an electricity quantity is converted into a heat amount (a conversion coefficient ξ_{e,h} is 6 MJ/(kW·h), an equivalent heating capacity of a gas turbine is close to that of the gas boiler, and a carbon emission of the gas turbine is also 0.065 kg/MJ. In addition, based on an average carbon emission of various industries, the present disclosure comprehensively determines that a carbon emission right quota for generating unit electric power is 0.728 kg/(kW·h), and a carbon emission right quota for generating unit thermal power is 0.102 kg/MJ. An equipment capacity, conversion efficiency, and other information involved in the park-level integrated energy system are shown in Table 1 and Table 2.

TABLE 1
Parameters of energy conversion equipment

| | Operation | | | |
|---|---|---|---|---|
| | and | | Energy | |
| | maintenance | | conversion | Ramping |
| Equipment | cost/ | Capacity/ | efficiency/ | constraint/ |
| name | (CNY/KW) | (kW) | (%) | (%) |
| Gas turbine | 0.03 | 1,000 | Electricity 30/heat 50 | 20 |
| Gas boiler | 0.03 | 800 | 80 | 20 |
| P2G | 0.025 | 200 | 60 | 20 |

TABLE 2
Parameters of energy storage equipment

| | Operation | | Constraints | Energy |
|---|---|---|---|---|
| | and | | on upper | charging and |
| | maintenance | | and lower | discharging |
| Equipment | cost/ | Capacity/ | capacity | efficiency/ |
| name | (CNY/KW) | (kW) | limits/(%) | (%) |
| Battery | 0.02 | 300 | 10, 90 | 95, 95 |
| Heat storage | 0.016 | 200 | 10, 90 | 98, 98 |
| tank | | | | |
| Gas storage | 0.01 | 500 | 10, 90 | 97, 95 |
| tank | | | | |

In the present disclosure, main results and analyses of optimizing parameters of a ladder-type carbon trading mechanism by using an IPSO algorithm are as follows:

### A. Impact Analysis of Parameters

Based on a calculation formula of a ladder-type carbon trading cost, it can be found that the mechanism mainly includes three parameters: a basic carbon trading price, a carbon emission interval length, and a carbon trading price growth rate. Impacts of these three parameters on the ladder-type carbon trading mechanism are analyzed below.

A1. Impact analysis of the basic carbon trading price

In this case, the carbon emission interval length is set to 2000 kg, and the carbon trading price growth rate is set to 0.25.

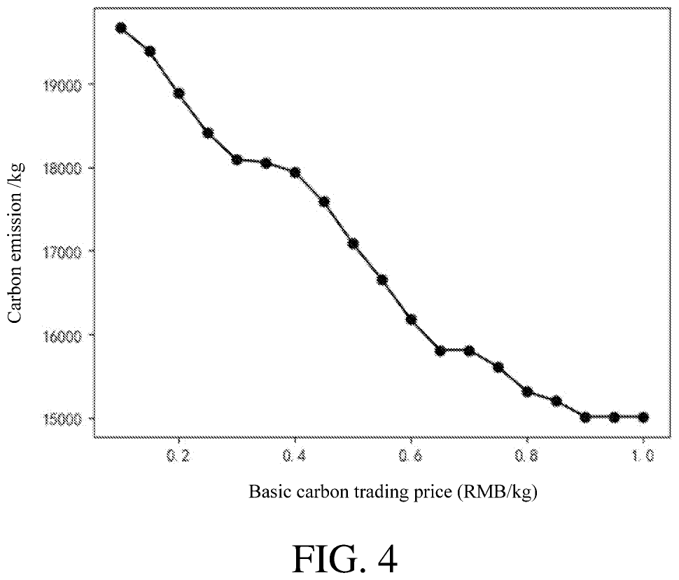

It can be seen from FIG. 4 that when the basic carbon trading price is less than 0.9 CNY/kg, with an increase of the basic carbon trading price, a larger proportion of a carbon emission cost in an objective function leads to a stronger constraint of the carbon trading mechanism on a carbon emission, which forces the system to reduce the carbon emission to reduce the carbon trading cost. Therefore, the carbon emission of the system gradually decreases. However, when the basic carbon trading price is greater than 0.9 CNY/kg, although the basic carbon trading price continues to increase, a power output of each equipment in the park-level integrated energy system is basically stable, and an overall carbon emission of the system also tends to be stable. In this case, an impact of the basic carbon trading price change on the carbon emission of the system is relatively weak. In this case, a minimum carbon emission of the system is 15053.652 kg.

### A2. Impact Analysis of the Carbon Emission Interval Length

In this case, the basic carbon trading price is set to 0.252 CNY/kg, and the carbon trading price growth rate is set to 0.25.

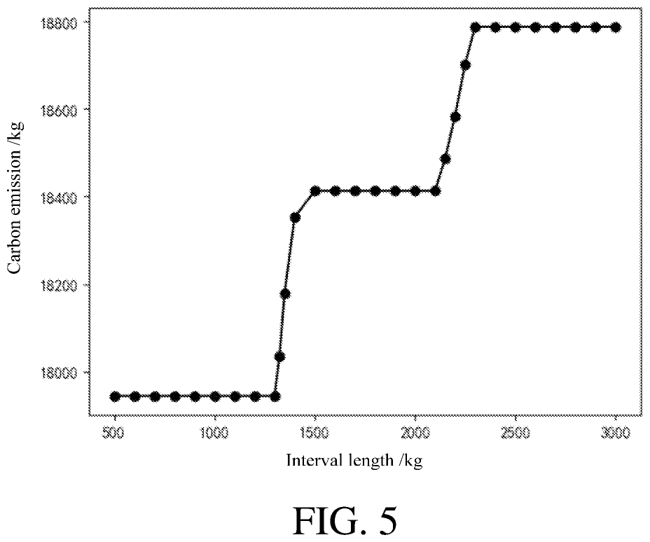

It can be seen from FIG. 5 that when the carbon emission interval length is within a range of [500, 1300] (in units of kg), because the interval length is relatively small, the carbon emission of the system is mostly traded in a carbon trading market at a high ladder-type price. In this case, a corresponding carbon trading cost is high, and a constraint of the carbon trading mechanism in the system is strengthened, so the carbon emission is reduced. When the carbon emission interval length is within a range of (1300, 2300] (in units of kg), the interval length becomes larger. However, due to inherent electric, gas, and other loads in the park-level integrated energy system, a carbon emission traded at the high ladder-type price in the carbon trading market becomes smaller, so a corresponding carbon trading cost becomes lower. Gradual reduction of the carbon trading cost has led to a decrease in a proportion of the carbon trading cost in the objective function, and the constraint of the carbon trading mechanism become weaker, so the carbon emission of the system is increasing. However, when the carbon emission interval length is within a range of (2300, 3000] (in units of kg), the carbon emission of the system is mostly traded in the carbon trading market at the basic price or a first ladder-type price. In this case, the ladder-type carbon trading is close to traditional carbon trading, and the carbon emission of the system is less affected by a change of the interval length, so the carbon emission is relatively stable. In this case, the minimum carbon emission of the system is 17948.725 kg.

### A3. Impact Analysis of the Price Growth Rate

In this case, the basic carbon trading price is set to 0.252 CNY/kg, and the carbon emission interval length is set to 2000 kg.

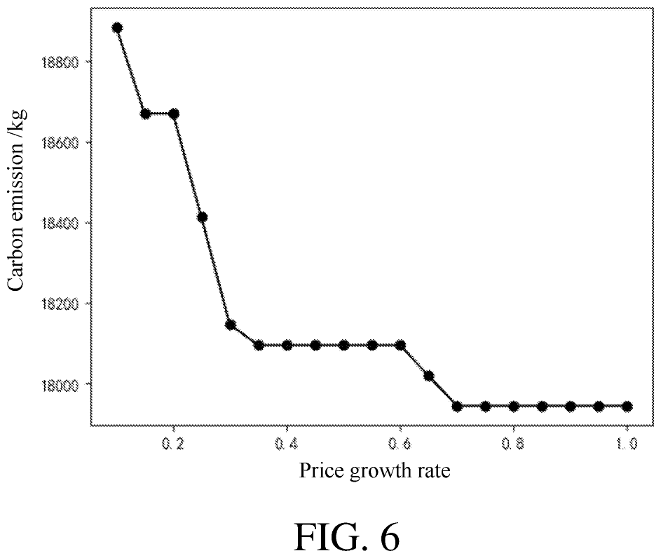

It can be seen from FIG. 6 that when the price growth rate is less than 0.7, the proportion of the carbon trading cost in the objective function gradually increases with an increase of the price growth rate, and the constraint of the carbon trading mechanism on the carbon emission of the system is also strengthened. In order to reduce the carbon emission of the system to lower the carbon trading cost, the system adjusts the power output of each equipment in the system during optimized dispatching, and more gas equipment with a lower emission coefficient is selected for energy supply. In addition, due to the electric, heat, and other loads in the park-level integrated energy system, when the price growth rate is greater than 0.7, the power output of each equipment in the system gradually becomes stable, and the carbon emission also becomes stable. In this case, the minimum carbon emission of the system is 17946.487 kg.

The above parameter analysis of the ladder-type carbon trading mechanism shows that when the basic carbon trading price is greater than 0.9 CNY/kg, the carbon emission of the system is minimum. In this case, the increase of the basic price cannot reduce the carbon emission of the park-level integrated energy system any longer, but only increases a comprehensive operating cost of the system. When the carbon emission interval length is less than or equal to 1300 kg, the carbon emission of the system is minimum, and the carbon emission of the system is strongly constrained by the ladder-type carbon trading mechanism. When the interval length is greater than 2300 kg, the carbon emission of the system is maximum, and the carbon emission of the system is poorly constrained by the mechanism. When the price growth rate is greater than 0.7, the carbon emission of the system is less affected by a change of the price growth rate. In this case, the carbon emission of the system is low and relatively stable. Therefore, reasonable settings of the basic carbon trading price, the carbon emission interval length, and the price growth rate can effectively achieve low-carbon performance for the system.

### B. Optimization of the Parameters of the Carbon Trading Mechanism Based on the IPSO Algorithm

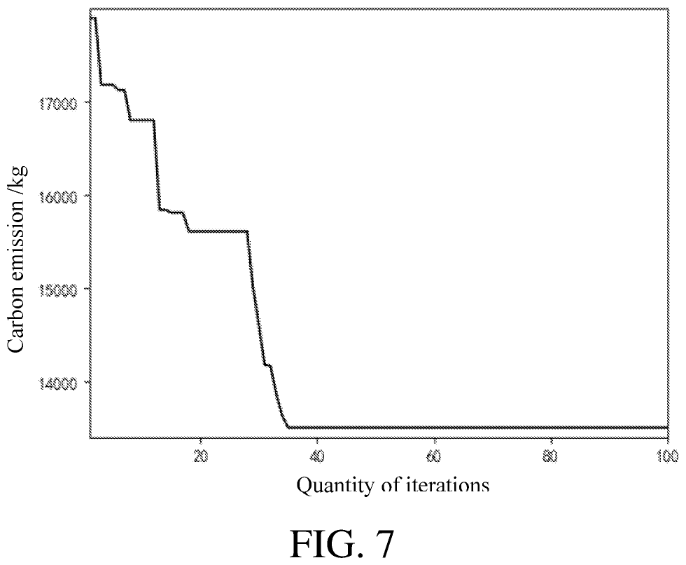

FIG. 7 shows an optimization process of the IPSO algorithm. The ladder-type carbon trading mechanism is introduced to the park-level integrated energy system, and the IPSO algorithm is used to optimize the parameters of the mechanism. A final parameter optimization result is that the basic carbon trading price set to 0.853 CNY/kg, the carbon emission interval length is set to 553.512 kg, the price growth rate is set to 0.823, and a corresponding carbon emission of the system is 13510.183 kg. The carbon emission of the system is reduced by 1543.469 kg compared with the minimum carbon emission of 15053.652 kg in A1, 4438.542 kg compared with the minimum carbon emission of 17948.725 kg in A2, and 4436.304 kg compared with the minimum carbon emission of 17946.487 kg in A3. In addition, optimization characteristics of the algorithm are used to make the parameters of the carbon trading mechanism adapt to a park-level actual situation, which avoids manual parameter formulation and improves work efficiency. This verifies superiority of the method for optimizing parameters of a ladder-type carbon trading mechanism based on an IPSO algorithm in low-carbon optimized dispatching of the park-level integrated energy system.

The present disclosure takes ladder-type carbon trading as a research object, introduces an intelligent algorithm, and proposes a method for optimizing parameters of a ladder-type carbon trading mechanism based on an IPSO algorithm. In addition, the present disclosure takes a park-level integrated energy system as a background to analyze and verify superiority of the proposed method. An example simulation result of the present disclosure shows that: (1) the IPSO algorithm is used to perform optimization based on a park-level actual situation, which avoids manual formulation of the parameters of the ladder-type carbon trading mechanism, and improves rationality of parameter formulation of the ladder-type carbon trading mechanism; (2) the reasonable parameter formulation can give full play to effectiveness of the carbon trading mechanism, thereby reducing a carbon emission of the park-level integrated energy system, and improving a low-carbon nature of the system.

Finally, it should be noted that: the above embodiments are merely intended to describe the technical solutions of the present disclosure, rather than to limit thereto; although the present disclosure is described in detail with reference to the above embodiments, it is to be appreciated by a person of ordinary skill in the art that modifications or equivalent substitutions may still be made to the specific implementations of the present disclosure, and any modifications or equivalent substitutions made without departing from the spirit and scope of the present disclosure shall fall within the protection scope of the claims of the present disclosure.

1. A method for optimizing parameters of a ladder-type carbon trading mechanism based on an improved particle swarm optimization (IPSO) algorithm, comprising the following steps:
(1) collecting information and operating data of a park-level integrated energy system, comprising a topology framework of the park-level integrated energy system, a capacity and efficiency of an equipment in the park-level integrated energy system, a carbon emission coefficient of a gas turbine, a carbon emission coefficient of a gas boiler, an equivalent carbon emission coefficient of electricity purchased by a superior, an operating cost of the park-level integrated energy system, a constraint on safe operation of the park-level integrated energy system, and information of electric, heat, and gas loads;
(2) establishing a mathematical model of the equipment in the park-level integrated energy system, wherein the mathematical model of the equipment in the park-level integrated energy system comprises a power-to-gas (P2G) equipment model, a gas turbine model, a gas boiler model, a battery model, a gas storage tank model, and a heat storage tank model;
(3) establishing a ladder-type carbon trading model, wherein the ladder-type trading model comprises a carbon emission right quota model of the park-level integrated energy system, an actual carbon emission model of the park-level integrated energy system, and a ladder-type carbon emission trading model, and a mathematical expression of a ladder-type carbon trading cost obtained based on the ladder-type carbon trading model is as follows:
$${C}_{{CO}_{2}} = \{ \begin{matrix}λ {EX}_{p} & {EX}_{p} \leq l \\ λ ( 1 + σ ) ( {EX}_{p} - l ) + λ l & l \leq {EX}_{p} \leq 2 l \\ λ ( 1 + 2 σ ) ( {EX}_{p} - 2 l ) + λ ( 2 + σ ) l & 2 l \leq {EX}_{p} \leq 3 l \\ λ ( 1 + 3 σ ) ( {EX}_{p} - 3 l ) + λ ( 3 + 3 σ ) l & 3 l \leq {EX}_{p} \leq 4 l \\ λ ( 1 + 4 σ ) ( {EX}_{p} - 4 l ) + λ ( 4 + 6 σ ) l & {EX}_{p} \geq 4 l\end{matrix}$$
wherein C_{CO}_{₂} represents the ladder-type carbon transaction cost; λ represents a basic carbon trading price; l represents a carbon emission interval length; σ represents a carbon trading price growth rate; and EXₚ represents a carbon emission right trading volume of the park-level integrated energy system;
(4) taking a minimum overall cost constituted by the system operating cost Cᵣᵤₙ of the park-level integrated energy system and the ladder-type carbon trading cost C_{CO}_{₂} as a goal of optimized low-carbon economic dispatching, and encapsulating a process of the optimized low-carbon economic dispatching of the park-level integrated energy system as a fitness function, wherein an input of the fitness function comprises three parameters of a ladder-type carbon trading mechanism, namely, the basic carbon trading price, the carbon emission interval length, and the carbon trading price growth rate, and an output of the fitness function is a carbon emission of the park-level integrated energy system; and
(5) introducing an improved particle swarm optimization (IPSO) algorithm to optimize the fitness function in the step (4), comprising adjusting an inertia weight in a particle swarm optimization (PSO) algorithm by taking an S-shaped function, a trigonometric function, and a random function as a carrier, and optimizing an acceleration factor in the PSO algorithm based on the trigonometric function to obtain optimization result information, wherein an optimization process comprises performing iterative optimization on the fitness function by taking a maximum quantity of iterations as a termination condition and a lowest carbon emission of the system as a goal, and the optimization result information comprises the basic carbon trading price, the carbon emission interval length, the carbon trading price growth rate, and the carbon emission of the park-level integrated energy system.

2. The method for optimizing parameters of a ladder-type carbon trading mechanism based on an IPSO algorithm according to claim 1, wherein
a mathematical expression of the P2G equipment model is as follows:
P_{gb_o}^{t}=η_{gb}P_{gb}^{t}
wherein P_{p2g_o}^{t} and P_{p2g}^{t} respectively represent an output and an input of P2G equipment at a time point t; and η_{p2g} represents P2G conversion efficiency;
a mathematical expression of the gas turbine model is as follows:
$$\{ \begin{matrix}{P}_{gt \_ e}^{t} & = {η}_{gte} {P}_{gt}^{t} \\ {P}_{gt \_ h}^{t} & = {η}_{gth} {P}_{gt}^{t}\end{matrix}$$
wherein P_{gt_e}^{t}, P_{gt_h}^{t}, and P_{gt}^{t} respectively represent an output electricity quantity, an output heat amount, and an input gas amount of the gas turbine at the time point t; and η_{gte} and η_{gth} respectively represent gas-to-power efficiency and gas-to-heat efficiency of the gas turbine;
a mathematical expression of the gas boiler model is as follows:
P_{gb_o}^{t}=η_{gb}P_{gb}^{t}
wherein P_{gb_o}^{t} and P_{gb}^{t} respectively represent an output and an input of the gas boiler at the time point t; and η_{gb} represents conversion efficiency of the gas boiler; and
an electricity/gas/heat storage model comprises three kinds of energy storage equipment: a battery, a heat storage tank, and a gas storage tank, and a unified universal model is adopted for processing, wherein the universal model comprises a balance constraint of stored energy, constraints on upper and lower limits of the stored energy, a constraint on equal quantities at the beginning and end of an energy storage cycle, and power constraints of energy charging and discharging, and a mathematical expression of the universal model is as follows:
$$\{ \begin{matrix}{E}_{x}^{t + 1} = {E}_{x}^{t} + ( {P}_{xchar}^{t} {η}_{xchar} - {P}_{xdis}^{t} / {η}_{xdis} ) Δ t \\ {E}_{x}^{min} \leq {E}_{x}^{t} \leq {E}_{x}^{max} \\ {E}_{x}^{24} = {E}_{x}^{1} \\ 0 \leq {P}_{xdis}^{t} \leq ( 1 - {n}_{x} ) {P}_{xdis}^{max} \\ 0 \leq {P}_{xchar}^{t} \leq {n}_{x} {P}_{xchar}^{max}\end{matrix}$$
wherein x represents an energy type, which is set to electricity, heat or gas; Eₓ^{t} represents stored energy of an energy storage system in a unit time period t; P_{xchar}^{t} and P_{xdis}^{t} respectively represent energy charging power and energy discharging power of the energy storage system; η_{xchar} and η_{xdis} respectively represent energy charging efficiency and energy discharging efficiency of the energy storage system; Eₓ^{max} and Eₓ^{min} respectively represent upper and lower limits of the stored energy of the energy storage system; Eₓ^{max} and Eₓ^{min} respectively represent stored energy of the energy storage system at the beginning and end of one-day dispatching, wherein it is required that the stored energy of the energy storage system returns to an original value after the one-day dispatching; P_{xchar}^{max} and P_{xdis}^{max} respectively represent upper limits of the energy charging power and the energy discharging power of the energy storage system; nₓ represents a variable ranging from 0 to 1, which is used to ensure that the energy storage system stores and discharges energy at different time in each time period, wherein when nₓ is 1, the energy storage system stores the energy; or when nₓ is 0, the energy storage system discharges the energy; and Δt represents the unit time period.

3. The method for optimizing parameters of a ladder-type carbon trading mechanism based on an IPSO algorithm according to claim 1, wherein the ladder-type carbon trading model established in the step (3) comprises the following sub-models:
a mathematical expression of the carbon emission right quota model is as follows:
$$\{ \begin{matrix}{EX}_{PIESo} = {EX}_{eo , buy} + {EX}_{g t o} + {EX}_{g b o} \\ {EX}_{eo , buy} = {μ}_{e} {\sum }_{t = 1}^{T} {P}_{e}^{t} \\ {EX}_{gto} = {μ}_{h} {\sum }_{t = 1}^{T} ( {P}_{gt}^{t} {η}_{gte} {δ}_{e , h} + {P}_{gt}^{t} {η}_{gth} ) \\ {EX}_{gbo} = {μ}_{h} {\sum }_{t = 1}^{T} {P}_{gb}^{t} {η}_{gb}\end{matrix}$$
where EX_{PIESo}, EX_{eo,buy}, EX_{gto}, and EX_{gbo} respectively represent a carbon emission right quota of the park-level integrated energy system, a carbon emission right quota of the electricity purchased by the superior, a carbon emission right quota of the gas turbine, and a carbon emission right quota of the gas boiler; μₑ and μₕ respectively represent a carbon emission right quota for generating unit electric power and a carbon emission right quota for generating unit thermal power; δ_{e,h} represent an electric power conversion parameter and a thermal power conversion parameter; Pₑ^{t}, P_{gt}^{t}, and P_{gb}^{t} respectively represent a quantity of electricity purchased by the superior, input power of the gas turbine, input power of the gas boiler at a time point t; η_{gte}, η_{gth}, and η_{gb} respectively represent gas-to-power efficiency of the gas turbine, gas-to-heat efficiency of the gas turbine, and conversion efficiency of the gas boiler; and T represents a dispatching cycle;
a mathematical expression of the actual carbon emission model is as follows:
$$\{ \begin{matrix}{EX}_{PIES} = {EX}_{e , buy} + {EX}_{gt} + {EX}_{gb} \\ {EX}_{e , buy} = {ξ}_{e} {\sum }_{t = 1}^{T} {P}_{e}^{t} \\ {EX}_{gt} = {ξ}_{h} {\sum }_{t = 1}^{T} ( {P}_{gt}^{t} {η}_{gte} {δ}_{e , h} + {P}_{gt}^{t} {η}_{gth} ) \\ {EX}_{gb} = {ξ}_{h} {\sum }_{t = 1}^{T} {P}_{gb}^{t} {η}_{gb}\end{matrix}$$
where EX_{PIES}, EX_{e,buy}, EX_{gt}, and EX_{gb} respectively represent an actual carbon emission of the park-level integrated energy system, an actual carbon emission of the electricity purchased by the superior, an actual carbon emission of the gas turbine, and an actual carbon emission of the gas boiler; and ξₑ and ξₕ respectively represent an actual carbon emission for generating the unit electric power and an actual carbon emission for generating the unit thermal power; and
an actual carbon emission right trading volume in a carbon trading market in the ladder-type carbon emission trading model is calculated according to the following formula:
$${EX}_{p} = {EX}_{PIESo} - {EX}_{PIES}$$
wherein EXₚ, EX_{PIESo}, and EX_{PIES} respectively represent the carbon emission right trading volume, the carbon emission right quota, and the actual carbon emission of the park-level integrated energy system.

4. The method for optimizing parameters of a ladder-type carbon trading mechanism based on an IPSO algorithm according to claim 1, wherein the step (4) specifically comprises the following procedure:
determining an objective function, comprehensively considering the system operating cost Cᵣᵤₙ of the park-level integrated energy system and the ladder-type carbon trading cost C_{CO}_{₂}, and building the goal of the optimized low-carbon economic dispatching, namely, a lowest comprehensive operating cost C, wherein the goal of the optimized low-carbon economic dispatching is expressed as follows:
$$C = min ( {C}_{run} + {C}_{{CO}_{2}} )$$
a mathematical expression of the system operating cost is as follows:
$$\{ \begin{matrix}{C}_{run} = {C}_{buy} + {C}_{save} \\ {C}_{buy} = {\sum }_{t = 1}^{T} {α}_{t} {P}_{e}^{t} + {\sum }_{t = 1}^{T} {β}_{t} {P}_{g}^{t} \\ {C}_{save} = {\sum }_{t = 1}^{T} ( {ψ}_{gt} {P}_{gt}^{t} + {ψ}_{gb} {P}_{gb}^{t} + {ψ}_{p 2 g} {P}_{p 2 g}^{t} + {ψ}_{e} {P}_{edis}^{t} + {ψ}_{h} {P}_{hdis}^{t} + {ψ}_{g} {P}_{gdis}^{t} )\end{matrix}$$
wherein C_{buy} represents an energy purchasing cost; Cₛₐᵥₑ represents an equipment maintenance cost; Pₑ^{t} and P_{g}^{t} respectively represent a quantity of electricity purchased and an amount of gas purchased in a unit time period t; αₜ and βₜ respectively represent an electricity price and a gas price in the time period t; ψ_{gt}, ψ_{gb}, ψ_{p2g}, ψₑ, ψₕ, and ψ_{g} respectively represent unit maintenance costs of the gas turbine, the gas boiler, P2G equipment, a battery, a heat storage tank, and a gas storage tank; P_{gt}^{t}, P_{gb}^{t} and P_{p2g}^{t} respectively represent input power of the gas turbine, the gas boiler, and the P2G equipment at a time point t; P_{edis}^{t} represents discharging power of the battery in the unit time period t; P_{gdis}^{t} represents gas discharging power of the gas storage tank in the unit period t; and P_{hdis}^{t} represents heat discharging power of the heat storage tank in the unit time period t;
a mathematical expression of the ladder-type carbon trading cost is as follows:
$${EX}_{p} = {EX}_{PIESo} - {EX}_{PIES}$$
$${C}_{{CO}_{2}} = \{ \begin{matrix}λ {EX}_{p} & {EX}_{p} \leq l \\ λ ( 1 + σ ) ( {EX}_{p} - l ) + λ l & l \leq {EX}_{p} \leq 2 l \\ λ ( 1 + 2 σ ) ( {EX}_{p} - 2 l ) + λ ( 2 + σ ) l & 2 l \leq {EX}_{p} \leq 3 l \\ λ ( 1 + 3 σ ) ( {EX}_{p} - 3 l ) + λ ( 3 + 3 σ ) l & 3 l \leq {EX}_{p} \leq 4 l \\ λ ( 1 + 4 σ ) ( {EX}_{p} - 4 l ) + λ ( 4 + 6 σ ) l & {EX}_{p} \geq 4 l\end{matrix}$$
wherein EXₚ, EX_{PIESo}, and EX_{PIES} respectively represent the carbon emission right trading volume, a carbon emission right quota, and an actual carbon emission of the park-level integrated energy system; C_{CO}_{₂} represents the ladder-type carbon trading cost; λ represents the basic carbon trading price; l represents the carbon emission interval length; and σ represents the carbon trading price growth rate;
the objective function comprises the following constraints: an electric, gas, and thermal power balance constraint, a wind power output constraint, a P2G equipment constraint, power output and ramping constraints of the gas turbine, power output and ramping constraints of the gas boiler, an electricity/gas/heat storage constraint, and electricity and gas purchasing constraints, wherein
the electric, gas, and thermal power balance constraint is as follows:
$$\{ \begin{matrix}{P}_{el}^{t} = {P}_{e}^{t} + {P}_{w}^{t} + {P}_{gt}^{t} {η}_{gte} + {P}_{edis}^{t} - {P}_{echar}^{t} - {P}_{p 2 g}^{t} \\ {P}_{gl}^{t} = {P}_{g}^{t} + {P}_{p 2 g}^{t} {η}_{p 2 g} + {P}_{gdis}^{t} - {P}_{gt}^{t} - {P}_{gchar}^{t} - {P}_{gb}^{t} \\ {P}_{hl}^{t} = {P}_{gt}^{t} {η}_{gth} + {P}_{hdis}^{t} + {P}_{gb}^{t} {η}_{gb} - {P}_{hchar}^{t}\end{matrix}$$
where P_{gl}^{t}, Pₕₗ^{t}, and Pₑₗ^{t} respectively represent power of the gas, heat, and electric loads in the park-level integrated energy system at the time point t; Pₑ^{t}, and P_{g}^{t} respectively represent a quantity of electricity purchased and an amount of gas purchased at the time point t; P_{w}^{t} represents wind power participating in dispatching at the time point t; P_{p2g}^{t}, P_{gt}^{t}, and P_{gb}^{t} respectively represent the input power of the P2G equipment, the gas turbine, and the gas boiler at the time point t; P_{gchar}^{t}, and P_{gdis}^{t} respectively represent gas storage power and gas discharging power of the gas storage tank at the time point t; P_{hchar}^{t}, and P_{hdis}^{t} respectively represent heat storage power and heat discharging power of the heat storage tank at the time point t; P_{echar}^{t}, and P_{edis}^{t} respectively represent charging power and discharging power of the battery at the time point t; η_{p2g} represents energy conversion efficiency of the P2G equipment; and η_{gte}, η_{gth}, and η_{gb} respectively represent gas-to-power efficiency of the gas turbine, gas-to-heat efficiency of the gas turbine, and conversion efficiency of the gas boiler;
the wind power output constraint is as follows:
0≤P_{w}^{t}≤P_{w}^{max}
where P_{w}^{max} represents an upper limit of a wind power output;
the P2G equipment constraint is as follows:
0≤P_{p2g}^{t}≤P_{p2gn}
wherein P_{p2gn} represents rated power of the P2G equipment;
the power output and ramping constraints of the gas turbine are as follows:
$$\{ \begin{matrix}0 \leq {P}_{gt}^{t} \leq {P}_{gtn} \\ Δ {P}_{gt}^{min} \leq {P}_{gt}^{t + 1} - {P}_{gt}^{t} \leq Δ {P}_{gt}^{max}\end{matrix}$$
where P_{gtn} represents rated power of the gas turbine; P_{gt}^{t} represents the input power of the gas turbine at the time point t; and ΔP_{gt}^{max} and ΔP_{gt}^{min} respectively represent upper and lower limits of a ramping rate of the gas turbine;
the power output and ramping constraints of the gas boiler are as follows:
$$\{ \begin{matrix}0 \leq {P}_{gb}^{t} \leq {P}_{gbn} \\ Δ {P}_{gb}^{min} \leq {P}_{gb}^{t + 1} - {P}_{gb}^{t} \leq Δ {P}_{gb}^{max}\end{matrix}$$
wherein P_{gbn} represents rated power of the gas boiler; P_{gb}^{t} represents the input power of the gas boiler at the time point t; and ΔP_{gb}^{max} and ΔP_{gb}^{min} respectively represent upper and lower limits of a ramping rate of the gas boiler;
the electricity/gas/heat storage constraint is as follows:
the battery, the heat storage tank, and the gas storage tank adopt a unified universal model for processing, comprising a balance constraint of stored energy, constraints on upper and lower limits of the stored energy, a constraint on equal quantities at the beginning and end of an energy storage cycle, and power constraints of energy charging and discharging:
$$\{ \begin{matrix}{E}_{x}^{t + 1} = {E}_{x}^{t} + ( {P}_{xchar}^{t} {η}_{xchar} - {P}_{xdis}^{t} / {η}_{xdis} ) Δ t \\ {E}_{x}^{min} \leq {E}_{x}^{t} \leq {E}_{x}^{max} \\ {E}_{x}^{24} = {E}_{x}^{1} \\ 0 \leq {P}_{xdis}^{t} \leq ( 1 - {n}_{x} ) {P}_{xdis}^{max} \\ 0 \leq {P}_{xchar}^{t} \leq {n}_{x} {P}_{xchar}^{max}\end{matrix}$$
wherein x represents an energy type, which is set to electricity, heat or gas; Eₓ^{t} represents stored energy of an energy storage system in the unit time period t; P_{xchar}^{t} and P_{xdis}^{t} respectively represent energy charging power and energy discharging power of the energy storage system; η_{xchar} and η_{xdis} respectively represent energy charging efficiency and energy discharging efficiency of the energy storage system; Eₓ^{max} and Eₓ^{min} respectively represent upper and lower limits of the stored energy of the energy storage system; Eₓ¹ and Eₓ²⁴ respectively represent stored energy of the energy storage system at the beginning and end of one-day dispatching, wherein it is required that the stored energy of the energy storage system returns to an original value after the one-day dispatching; P_{xchar}^{max} and P_{xdis}^{max} respectively represent upper limits of the energy charging power and the energy discharging power of the energy storage system; and nₓ represents a variable ranging from 0 to 1, which is used to ensure that the energy storage system stores and discharges energy at different time in each time period, wherein when nₓ is 1, the energy storage system stores the energy; or when the variable is 0, the energy storage system discharges the energy; and
the park-level integrated energy system is connected to an external power network and natural gas network, and an energy exchange scope of the park-level integrated energy system needs to be constrained, wherein the electricity and gas purchasing constraints are determined as follows:
$$\{ \begin{matrix}{P}_{e}^{min} \leq {P}_{e}^{t} \leq {P}_{e}^{max} \\ {P}_{g}^{min} \leq {P}_{g}^{t} \leq {P}_{g}^{max}\end{matrix}$$
wherein Pₑ^{max} and Pₑ^{min} respectively represent upper and lower limits of electric power purchased by the system in the unit time period t; and P_{g}^{max} and P_{g}^{min} respectively represent upper and lower limits of natural gas power purchased by the system.

5. The method for optimizing parameters of a ladder-type carbon trading mechanism based on an IPSO algorithm according to claim 1, wherein in the step (5), the introducing an IPSO algorithm to optimize the fitness function in the step (4) specifically comprises:
improving the inertia weight: taking the S-shaped function, the trigonometric function, and the random function as the carrier, and optimizing and adjusting ω, wherein an expression for improving the inertia weight is as follows:
$$ω = \frac{1}{1 + {e}^{- \frac{k}{iter}}} - 0.1 + rand * cos ( \frac{π}{2} * \frac{iter}{Iter\_max} )$$
wherein ω represents the inertia weight; iter represents a current quantity of iterations; Iter_max represents the maximum quantity of iterations; rand represents a uniformly distributed random number of [0,1]; and k represents a constant, and k=30;
improving the acceleration factor: improving and nonlinearly adjusting the acceleration factor based on the trigonometric function, wherein a calculation formula for improving the acceleration factor is as follows:
$${c}_{1} = 2 - 1.5 * sin ( \frac{π}{2} * \frac{iter}{Iter\_max} )$$
$${c}_{2} = 0.5 + 1.5 * sin ( \frac{π}{2} * \frac{iter}{Iter\_max} )$$
wherein c₁ and c₂ represent acceleration factors; iter represents the current quantity of iterations; Iter_max represents the maximum quantity of iterations; and value ranges of c₁ and c₂ are [0.5,2]; and
optimizing the IPSO algorithm, which specifically comprises step 1 to step 8:
step 1: initializing the algorithm, and setting a swarm size m, a particle dimension d, the acceleration factors C₁ and C₂, a maximum flight speed Vₘₐₓ of a particle, a minimum flight speed Vₘᵢₙ of the particle, and the maximum quantity of iterations Iter_max;
step 2: randomly initializing a speed and a position of the particle within a specified search range;
step 3: calculating an inertia weight and an acceleration factor of the particle before a next iteration based on the calculation formula for improving the inertia weight and the calculation formula for improving the acceleration factor;
step 4: calculating the speed and the position of the particle;
step 5: calculating a fitness value fᵢ of each particle based on the set fitness function, calculating an individual extremum P_{best} and a global extremum G_{best} based on fᵢ, comparing fᵢ with the individual extremum P_{best}, and if a result shows that fᵢ is superior to the individual extremum P_{best}, setting P_{best}=fᵢ;
step 6: comparing the individual extremum P_{best} of each particle with the global extremum G_{best} in a swarm, and if a result shows that G_{best} is superior to the global extremum G_{best}, setting G_{best}=P_{best};
step 7: determining whether the termination condition described in the step (5) is met; and if the termination condition is met, stopping the operation and performing step 8; or if the termination condition is not met, returning to the step 3; and
step 8: outputting a global optimal value.
